(19) United States
(12) Patent Application Publication
(10) Pub. No.: US 2019/0074035 A1
(43) Pub. Date: Mar. 7, 2019

(54) INTERFACE DEVICE FOR DATA EDIT, CAPTURE DEVICE, IMAGE PROCESSING DEVICE, DATA EDITING METHOD AND RECORDING MEDIUM RECORDING DATA EDITING PROGRAM

(71) Applicant: Olympus Corporation, Tokyo (JP)

(72) Inventors: Kazuhiro HANEDA, Hachioji-shi (JP); Shinsuke HOMMA, Hino-shi (JP); Kazuhiko Osa, Hachioji-shi (JP); Osamu NONAKA, Sagamihara-shi (JP)

(21) Appl. No.: 16/124,082

(22) Filed: Sep. 6, 2018

(30) Foreign Application Priority Data
Sep. 7, 2017 (JP) 2017-172345

(51) Int. Cl. G11B 27/028; H04N 21/6587; G11B 27/031; G11B 19/02; H04N 5/765

(52) U.S. Cl. CPC G11B 27/028; H04N 21/6587; H04N 5/765; G11B 19/022; G11B 27/031

(57) ABSTRACT

An interface device includes a control circuit configured to (1) acquire from a capture device related data for checking a content of recording data recorded in a recording medium of the capture device, and (2) play back the related data to be viewable on a setting screen, an operation unit configured to accept an operation of setting of playback specifications on the setting screen, and a communication circuit configured to transmit playback specification information indicating the set playback specifications to the capture device.

### CROSS-REFERENCE TO RELATED APPLICATIONS

This application is based upon and claims the benefit of priority from the prior Japanese Patent Application No. 2017-172345, filed September 7, the entire contents of which are incorporated herein by reference.

### BACKGROUND OF THE INVENTION

### 1. Field of the Invention

The present invention relates to an interface device for data editing, a capture device, an image processing device, a content editing method and a recording medium recording a content editing program.

### 2. Description of the Related Art

Various techniques relating to editing of recording data such as an image recorded by using a capture device, e.g., an imaging device such as a digital video camera and a voice recording device such as an IC recorder, including a technique proposed in Jpn. Pat. Appln. KOKAI Publication No. 2010-154302, have been proposed. This kind of recording data editing is performed by a user operating an operation unit provided in a capture device while looking at a display provided in the capture device, or by a user operating a personal computer (PC) after transferring recording data from a capture device to the PC.

### BRIEF SUMMARY OF THE INVENTION

An interface device according to a first aspect of the present invention comprises a control circuit configured to (1) acquire from a capture device related data for checking a content of recording data recorded in a recording medium of the capture device, and (2) play back the related data to be viewable on a setting screen, an operation unit configured to accept an operation of setting of playback specifications on the setting screen, and a communication circuit configured to transmit playback specification information indicating the set playback specifications to the capture device.

A data editing method according to a second aspect of the present invention comprises displaying on a display a setting screen for setting playback specification of recording data recorded in a recording medium of a capture device, acquiring from the capture device related data for checking a content of the recording data and playing back the related data along with display of the setting screen, accepting an operation of setting of the playback specifications on the setting screen, and transmitting to the capture device playback specification information indicating the set playback specifications.

A storage medium according to a third aspect of the present invention stores a data editing program to cause a computer to execute displaying on a display a setting screen for setting playback specifications of recording data recorded in a recording medium of a capture device, acquiring from the capture device related data for checking the content of the recording data and playing back the related data along with display of the setting screen, accepting an operation of setting of the playback specifications on the setting screen, and transmitting to the capture device playback specification information indicating the set playback specifications.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a communication system including an interface device for data editing according to an embodiment of the present invention.

FIG. 2 is a diagram showing a configuration example of the interface device.

FIG. 3 is a diagram showing a configuration example of a capture device.

FIG. 4 is a diagram showing a configuration example of an image processing device.

FIG. 5A is a diagram for explaining an outline of an operation of a communication system.

FIG. 5B is a diagram for explaining an outline of an operation of a communication system.

FIG. 6 is a diagram showing a configuration of a smartphone as a specific example of the interface device.

FIG. 7 is a diagram showing a configuration of a digital camera as a specific example of the capture device.

FIG. 8 is a diagram showing a configuration of a server apparatus as a specific example of the image processing device.

FIG. 9 is a flowchart showing an operation of a digital camera.

FIG. 10A is a flowchart showing an operation of a smartphone.

FIG. 10B is a flowchart showing an operation of a smartphone.

FIG. 11A is a diagram showing a display example of a setting screen.

FIG. 11B is a diagram showing a display example of a setting screen.

FIG. 11C is a diagram showing a display example of a setting screen.

FIG. 11D is a diagram showing a display example of a setting screen.

FIG. 11E is a diagram showing a display example of a setting screen.

FIG. 11F is a diagram showing a display example of a setting screen.

FIG. 11G is a diagram showing a display example of a setting screen.

FIG. 11H is a diagram showing a modification of a display example of a setting screen.

FIG. 12 is a diagram showing an example of playback specification information when recording data is a movie image.

FIG. 13 is a flowchart showing an operation of a server apparatus.

FIG. 14 is a diagram for explaining an example of editing processing.

FIG. 15 is a diagram showing a playback example of edited recording data.

### DETAILED DESCRIPTION OF THE INVENTION

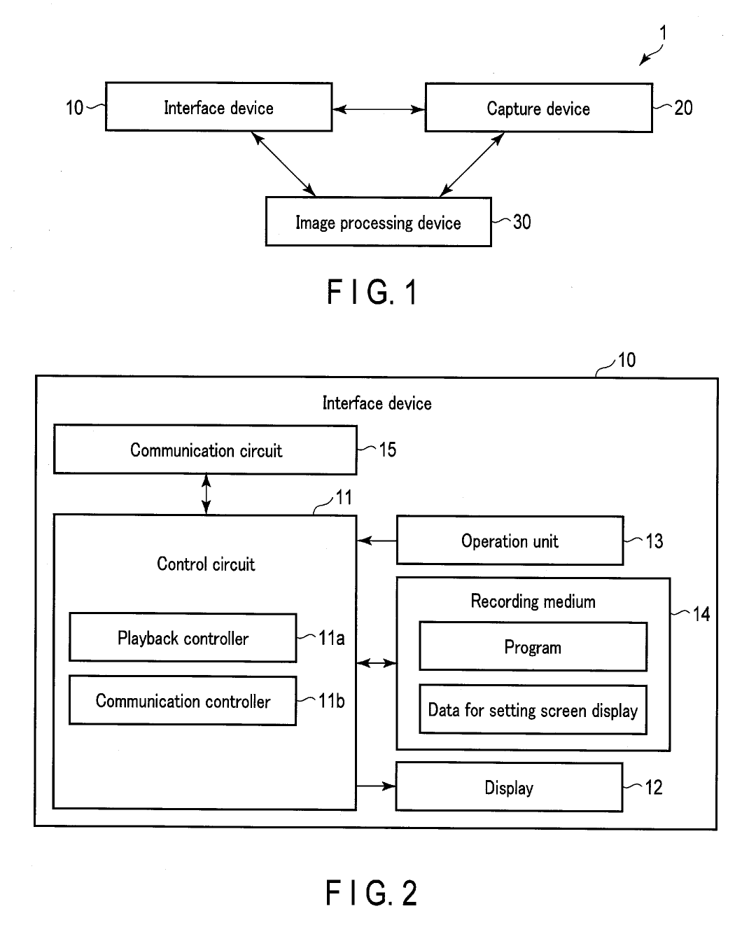

Hereinafter, an embodiment of the present invention will be described with reference to the drawings. FIG. 1 is a block diagram showing a configuration of a communication system including an interface device for data editing according to an embodiment of the present invention. A communication system 1 shown in FIG. 1 includes an interface device 10, a capture device 20, and an image processing device 30. The interface device 10, the capture device 20, and the image processing device 30 are configured to communicate with one another.

The interface device 10 is a device for performing an operation for editing recording data recorded in a recording medium of the capture device 20. The interface device 10 includes a smartphone, a tablet terminal, and a portable game console, etc. In accordance with a user's operation, the interface device 10 generates playback specification information indicating playback specifications of recording data recorded in the recording medium of the capture device 20, and transmits the generated playback specification information to the capture device 20. The playback specification information is information writing a “recipe” for instructing how to play back the recording data to the capture device. As will be described later, the capture device 20 or the image processing device 30 perform editing processing so that the recording data recorded in the recording medium of the capture device 20 is played back in accordance with the playback specification information.

The capture device 20 acquires recording data, and records the recording data in the recording medium. The capture device 20 is a device that acquires an image as recording data, e.g., a digital camera. The digital camera is a digital still camera or a digital movie camera. The recording data may be constituted by a plurality of images. The plurality of images in this case is, for example, frames of a movie image. In addition, the plurality of images in this case are a plurality of still images. The capture device 20 may be a device that acquires a voice as recording data, e.g., a voice recorder.

As described above, the capture device 20 performs editing processing so that the recording data is played back in accordance with the playback specification information in response to a request from the interface device 10. The capture device 20 requests the image processing device 30 to perform data editing processing as necessary.

The image processing device 30 includes a recording medium for recording separately from the capture device 20 the recording data acquired by the capture device 20. The image processing device 30 performs editing processing of the recording data in response to a request from the capture device 20. The image processing device 30 is, for example, a server apparatus configured to communicate with the capture device 20. The image processing device 30 is, for example, a personal computer (PC) configured to communicate with the capture device 20. The editing processing of content by the image processing device 30 may be performed in accordance with a request from the interface device 10. In this case, the image processing device 30 acquires the recording data from the capture device 20, and performs the editing processing for the acquired recording data.

In this way, it is expected in the age of IoT (Internet of Things) that various kinds of equipment cooperate according to characteristics, ease of operation, and purpose of use of the equipment, and a role or characteristics of an operating user. If editing of recording data recorded in a capture device that acquires information that everyone can enjoy or make use of can be performed on a portable terminal such as a smartphone that a user carries in everyday life and is familiar with, convenience for a wide range of users would be enhanced. However, in general, the volume of recording data, such as an image to be operated on a capture device such as a digital camera, tends to be larger than the volume of recording data to be operated easily on a smartphone. Not only would a load of arithmetic processing to be described later become a problem, in a case of transferring such large-capacity data from a capture device to a portable terminal, a communication load would easily increase. This would result in processing the large-capacity data in the portable terminal. Since data processing in a portable terminal is usually performed by software processing, a processing load easily increases due to the processing of large-capacity data. This is not preferable in consideration of other functions and power consumption as well.

The present invention has been made in consideration of the above circumstances, and can provide a user-friendly solution in that a plurality of equipment can reasonably cooperate by providing an interface device for data editing that enables easy editing of recording data recorded in a capture device, which is a dedicated purpose device, by using a portable terminal such as a smartphone carried in everyday life, a capture device to be coordinated with such an interface device, an image processing device, and a data editing method and a data editing program. In this case, it is necessary to determine and simplify “related data” to be transferred between the interface device and the capture device, otherwise, it takes a lot of time and labor for the important editing processing.

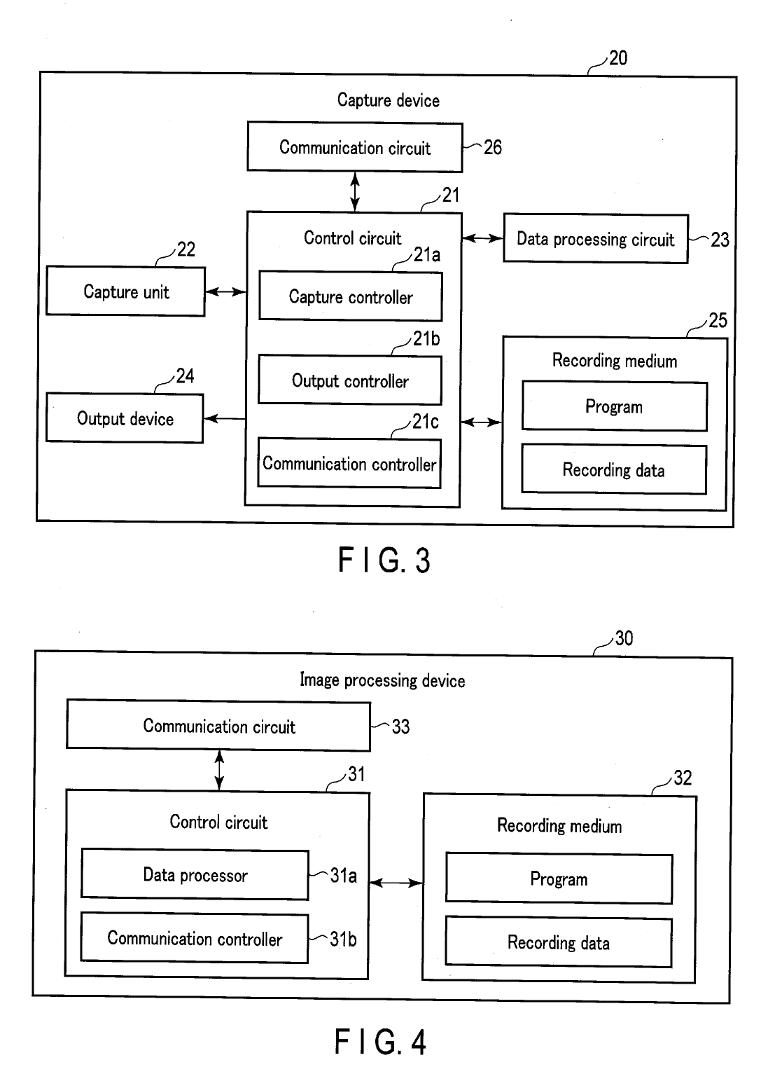

FIG. 2 is a diagram showing a configuration example of an interface device 10. As shown in FIG. 2, the interface device 10 includes a control circuit 11, a display 12, an operation unit 13, a recording medium 14, and a communication circuit 15.

The control circuit 11 is a control circuit configured by hardware, such as a CPU. The control circuit 11 controls an operation of the interface device 10. The control circuit 11 includes a playback controller 11a and a communication controller 11b. The playback controller 11a controls display of an image on the display 12. The playback controller 11a in the present embodiment displays a setting screen for a user to set playback specifications of the content on the display 12. The playback controller 11a also plays back related data transmitted from the capture device 20 at the time of display of the setting screen. The related data is data for the user to check the content of recording data in the interface device 10. The related data is preferably data with a data capacity smaller than original recording data. If the recording data is an image, the related data is, for example, an image generated by lowering a quality of an original image. Lowering the image quality includes reduction, thinning, etc. If the recording data is constituted by a voice, the related data is, for example, a voice to be generated by lowering a quality of sound (thinning, etc.) of an original voice. Lowering the image quality includes thinning, etc. If the recording data is constituted by time series data, such as a movie image and a voice, the related data may be an image or a voice to be streaming-transmitted (stream transmission) from the capture device 20. Furthermore, if the recording data is constituted by time series data, such as a movie image and a voice, the related data may be an image or a voice extracted from a movie image or a voice during playback in the capture device 20. The communication unit lib controls communications by the communication circuit 15. The playback controller 11a and the communication controller 11b are, for example, realized by using software. These may of course be realized by using hardware.

The display 12 displays various kinds of images. As described above, the display 12 in the present embodiment displays at least a setting screen for setting playback specifications of recording data. Data for setting screen display necessary for displaying the setting screen is, for example, recorded in the recording medium 14.

The operation unit 13 includes various kinds of operation members for the user to perform various kinds of operations for the interface device 10. The operation members include mechanical operation members, such as a button and a switch, and a touch panel.

Various kinds of programs to be executed in the control circuit 11 are recorded in the recording medium 14. The programs include an editing program for editing recording data. As described above, in the recording medium 14, data for setting screen display necessary for displaying the setting screen to set playback specifications of the recording data on the display 12 is recorded.

The communication circuit 15 includes a circuit for the interface device 10 to communicate with other equipment. Communications between the interface device 10, and the capture device 20 or the image processing device 30 are performed by, for example, wireless communication. Communications between the interface device 10 and the capture device 20 or the image processing device 30 may be performed by wired communication.

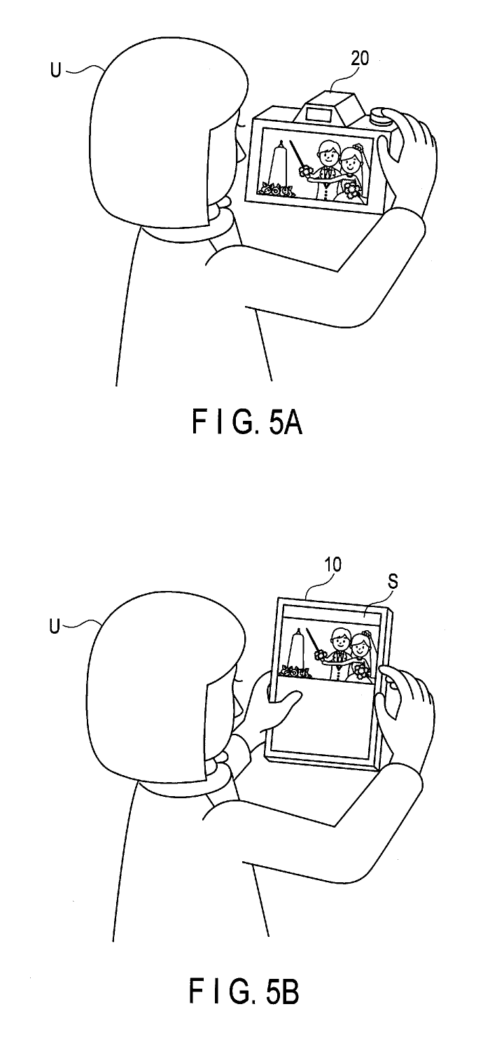

FIG. 3 is a diagram showing a configuration example of the capture device 20. As shown in FIG. 3, the capture device 20 includes a control circuit 21, a capture unit 22, a data processing circuit 23, an output device 24, a recording medium 25, and a communication circuit 26.

The control circuit 21 is a control circuit configured by hardware, such as a CPU. The control circuit 21 controls an operation of the capture device 20. The control circuit 21 includes a capture controller 21a, an output controller 21b, and a communication controller 21c. The capture controller 21a controls acquisition of recording data by the capture unit 22. For example, the capture controller 21a controls acquisition of an image by the capture unit 22. In addition, the capture controller 21a controls acquisition of a voice by the capture unit 22. The output controller 21b controls output of recording data to the output device 24. The output controller 21b displays an image as recording data on a display as the output device 24. The output controller 21b outputs a voice as recording data from a speaker as the output device 24. The communication controller 21c controls communications by the communication circuit 26. The capture controller 21a, the output controller 21b, and the communication controller 21c are, for example, realized by using software. These may of course be realized by using hardware.

The capture unit 22 acquires recording data. For example, the capture unit 22 includes a lens and an imaging element. In addition, the capture unit 22 includes a microphone, for example.

The data processing circuit 23 processes the recording data acquired by the capture unit 22. For example, the data processing circuit 23 includes an image processing circuit. The data processing circuit 23 includes a voice processing circuit. The processing of the recording data in the data processing circuit 23 includes the processing necessary for recording the recording data acquired by the capture unit 22 in the recording medium 25, and the above-described editing processing.

The output device 24 outputs the recording data, etc. recorded in the recording medium 25 so that the user can see. For example, if the recording data is an image, the output device 24 includes a display. For example, if the recording data is a voice, the output device 24 includes a speaker.

Various kinds of programs to be executed in the control circuit 21 are recorded in the recording medium 25. The recording data is recorded in the recording medium 25. The recording data is recorded in a compressed state in the data processing circuit 23.

The communication circuit 26 includes a circuit for the capture device 20 to communicate with other equipment. Communications between the capture device 20 and the interface device 10 or the image processing device 30 are performed by, for example, wireless communication. Communications between the capture device 20 and the interface device 10 or the image processing device 30 may be performed by wired communication.

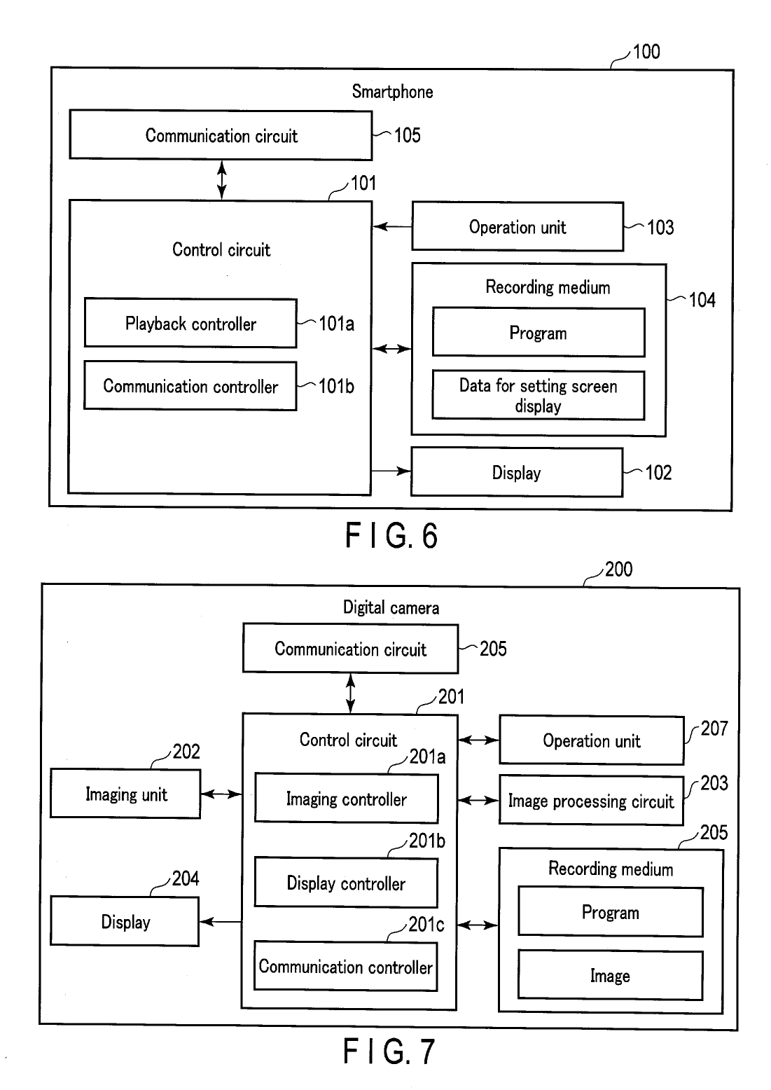

FIG. 4 is a diagram showing a configuration example of the image processing device 30. As shown in FIG. 4, the image processing device 30 includes a control circuit 31, a recording medium 32, and a communication circuit 33.

The control circuit 31 is a control circuit comprising hardware, such as a CPU. The control circuit 31 controls an operation of the image processing device 30. The control circuit 31 includes a data processor 31a and a communication controller 31b. The data processor 31a corresponds to the data processing circuit 23 of the capture device 20, and performs editing processing for the recording data acquired by the capture device 20. The communication controller 31b controls communications by the communication circuit 33. The data processor 31a and the communication controller 31b are, for example, realized by using software. Of course these may also be realized by using hardware.

Various kinds of programs to be executed in the control circuit 31 are recorded in the recording medium 32. The recording data transmitted from the capture device 20 is recorded in the recording medium 32.

The communication circuit 33 includes a circuit for the image processing device 30 to communicate with other equipment. Communications between the image processing device 30 and the interface device 10 or the capture device 20 are performed by, for example, wireless communication. Communications between the image processing device 30 and the interface device 10 or the capture device 20 may be performed by wired communication.

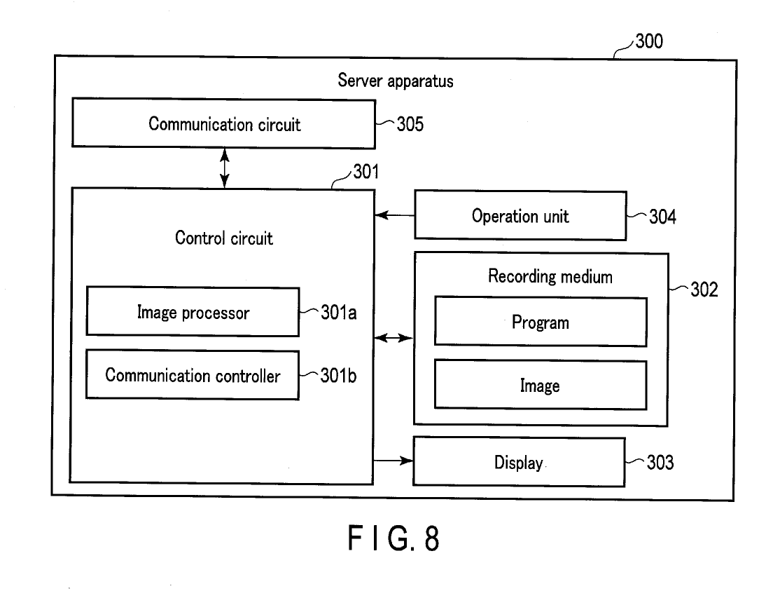

In the above-described configuration, in the present embodiment, the user first acquires the recording data by using the capture device 20 as shown in FIG. 5A. FIG. 5A is an example that a user U is taking a movie image by using a digital camera as the capture device 20. As a result, a movie image as recording data is recorded in the recording medium 25 of the capture device 20.

Thereafter, the user U operates the interface device 10 while looking at a setting screen S and sets playback specifications of the recording data, as shown in FIG. 5B. Herein, in the present embodiment, the recording data itself recorded in the capture device 20 is not transmitted to the interface device 10, and only related data for checking the content of the recording data is transmitted to the interface device 10. On the setting screen S, the related data is played back. The user U sets playback specifications while checking the content of the recording data based on the played-back related data. For example, FIG. 5B is an example in which the user U is setting playback specifications of a movie image imaged by the capture device 20 by operating a touch panel provided in a smartphone as the interface device 10. For example, not the entire movie image, but an image representing the content of the movie image is displayed on the setting screen S. The image representing the content of the movie image is, for example, a thumbnail image of a specific frame.

After setting of the playback specifications, playback specification information representing the content of the playback specification is generated in the interface device 10. Then, the playback specification information is transmitted from the interface device 10 to the capture device 20. In the capture device 20, editing processing of the recording data is performed so that the recording data can be played back in accordance with the playback specification information. This editing processing is performed in the image processing device 30 as necessary. Herein, the user may not necessarily be a particular person, but may be more than one person. There is a case where it is better for editing work, etc. to be performed by a plurality of members. When editing work is performed by a plurality of members, etc., it is especially important to make it possible to use smartphones, etc., which have become common around the globe and are carried by many people, as the interface device.

As described above, in the present embodiment, only the operation for editing of the recording data recorded in the recording medium of the capture device 20 is performed in the interface device 10, and actual editing processing is performed in the capture device 20 or the image processing device 30. Thus, a processing load in the interface device 10 can be reduced. Since communication of the recording data itself is not performed, a communication load in the interface device 10 can be reduced.

Hereinafter, the present embodiment will be more specifically described. In descriptions of specific examples below, descriptions redundant with the above descriptions will be omitted or simplified as appropriate.

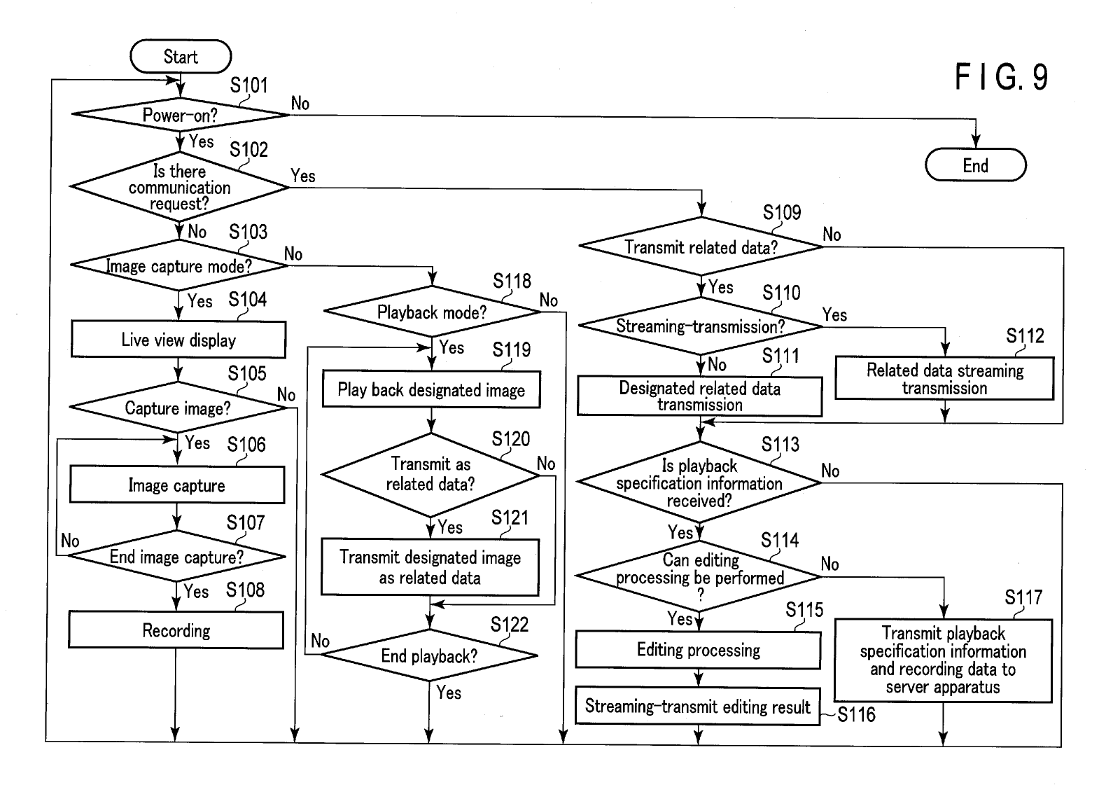

FIG. 6 is a diagram showing a configuration of a smartphone as a specific example of the interface device 10. As shown in FIG. 6, a smartphone 100 includes a control circuit 101, a display 102, an operation unit 103, a recording medium 104, and a communication circuit 105. Although not shown in FIG. 6, the smartphone 100 may include functions provided in normal smartphones, such as a telephone call function and an image capture function.

The control circuit 101 corresponds to the control circuit 11, and is a control circuit configured by hardware, such as a CPU. The control circuit 101 includes a playback controller 101a and a communication controller 101b, similar to the control circuit 11. The playback controller 101a and the communication controller 101b are realized by, for example, using software. These may of course also be realized by using hardware.

The display 102 corresponds to the display 12. The display 102 which is, for example, a liquid crystal display or an organic EL display, displays various types of images.

The operation unit 103 corresponds to the operation unit 13, and includes various kinds of operation units for the user to perform various kinds of operations for the smartphone 100. The operation members include mechanical operation members such as a button and a switch, and a touch panel.

The recording medium 104 corresponds to the recording medium 14, and includes, for example, a flash memory and a RAM. Various kinds of programs to be executed in the control circuit 11 are recorded in the recording medium 104. In addition, data for setting a screen display necessary for displaying a setting screen to set playback specifications of recording data on the display 102 is recorded in the recording medium 104. Note that the data for setting screen display may be included, along with a data editing program, in an application for smartphones.

The communication circuit 105 corresponds to the communication circuit 15. Herein, the communication circuit 105 may include a plurality of types of communication circuits. For example, the communication circuit 105 may include a communication circuit corresponding to a mobile phone communication, a communication circuit corresponding to a Wi-Fi (registered trademark) communication, and a communication circuit corresponding to a Bluetooth (registered trademark) communication (BLE communication). For example, for communication of related data, etc., the Wi-Fi communication, which is relatively a large capacity communication, is used. When transmitting an instruction to a digital camera 200, etc., the BLE communication, which is a relatively low-power-consumption communication, is used.

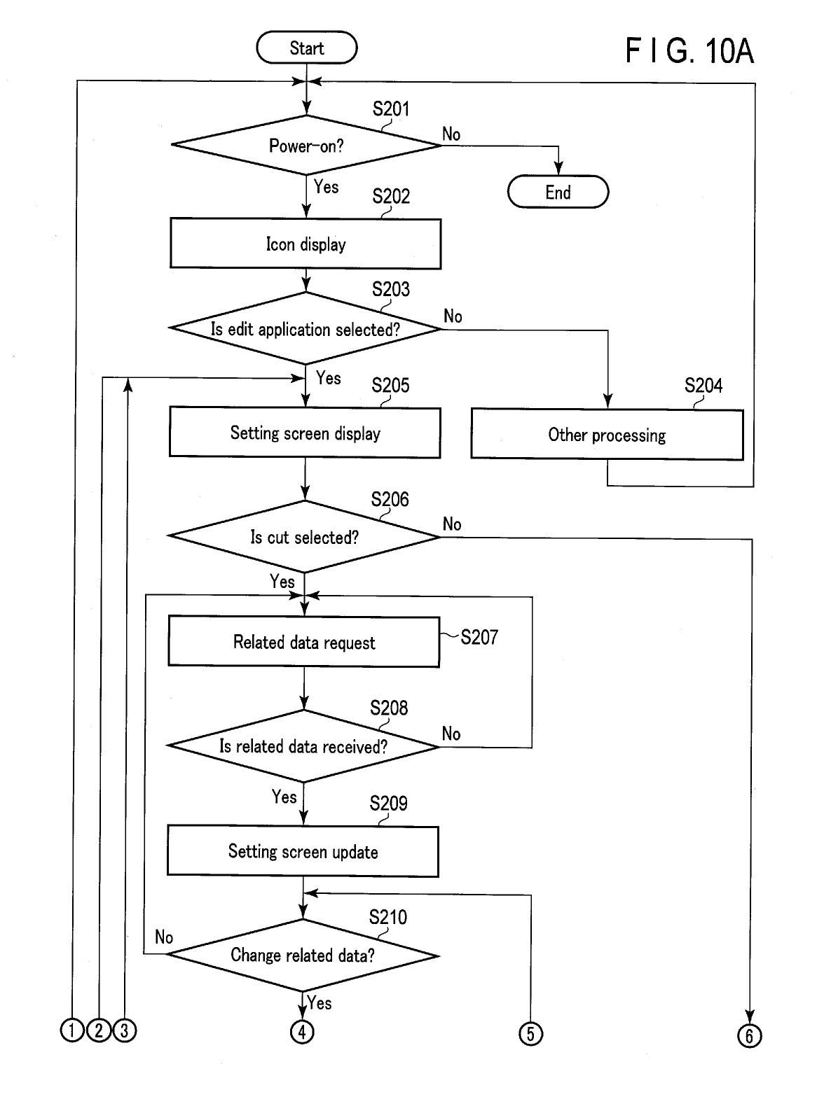

FIG. 7 is a diagram showing a configuration of a digital camera as a specific example of the capture device 20. As shown in FIG. 7, the digital camera 200 includes a control circuit 201, an imaging unit 202, an image processing circuit 203, a display 204, a recording medium 205, a communication circuit 206, and an operation unit 207.

The control circuit 201 corresponds to the control circuit 21, and is a control circuit configured by hardware, such as a CPU. The control circuit 201 includes an imaging controller 201a, a display controller 201b, and a communication controller 201c. The imaging controller 201a corresponds to the capture controller 21a, and controls acquisition of an image by the imaging unit 202. The display controller 201b corresponds to the output controller 21b, and controls display of an image in the display 204. The communication controller 201c corresponds to the communication controller 21c, and controls communication by the communication circuit 206. The imaging controller 201a, the display controller 201b, and the communication controller 201c are realized by, for example, using software. These may of course also be realized by using hardware.

The imaging unit 202 captures an image of an object, and acquires image data relating to the object. The imaging unit 202 includes a lens and an imaging element. The lens forms an image of a luminous flux from an object (not shown) on a receiving surface of the imaging element. The lens may include a zoom lens and a focus lens. The imaging element is, for example, a CMOS sensor, and converts a luminous flux received on a receiving surface into an image signal, which is an electric signal. The imaging element also performs pre-processing, such as amplifying and digitalizing the image signal to generate image data.

The image processing circuit 203 corresponds to the data processing circuit 23, and applies image processing for recording to the image data acquired by the imaging unit 202. The image processing for recording includes, for example, white balance correction processing, gamma correction processing, color correction processing, noise rejection processing, resize processing, and compression processing. In addition, the image processing circuit 203 applies editing processing to the image data recorded in the recording medium 205. The editing processing includes processing of applying special effects to an image to be played back, processing of applying a BGM to an image to be played back, and processing of applying a caption to an image to be played back. Furthermore, the editing processing includes processing of changing camera-blocking of a movie image, processing of changing a playback time of each cut, and processing of applying transition effects at the time of cut switching. The processing of changing camera-blocking is processing of changing a playback order of cuts.

The display 204 corresponds to the display 24. The display 204 which is, for example, a liquid crystal display or an organic EL display, displays various types of images.

The recording medium 205 corresponds to the recording medium 25, and includes, for example, a flash memory and a RAM. Various kinds of programs to be executed in the control circuit 201 are recorded in the recording medium 205. Image data is recorded in a compressed state in the recording medium 205.

The communication circuit 206 corresponds to the communication circuit 26. Herein, the communication circuit 206 may include a plurality of kinds of communication circuits. For example, the communication circuit 206 may include a communication circuit corresponding to the Wi-Fi communication, and a communication circuit corresponding to the Bluetooth communication (BLE communication).

The operation unit 207 includes various kinds of operation members for the user to perform various kinds of operations for the digital camera 200. The operation members include mechanical operation members such as a button and a switch, and a touch panel.

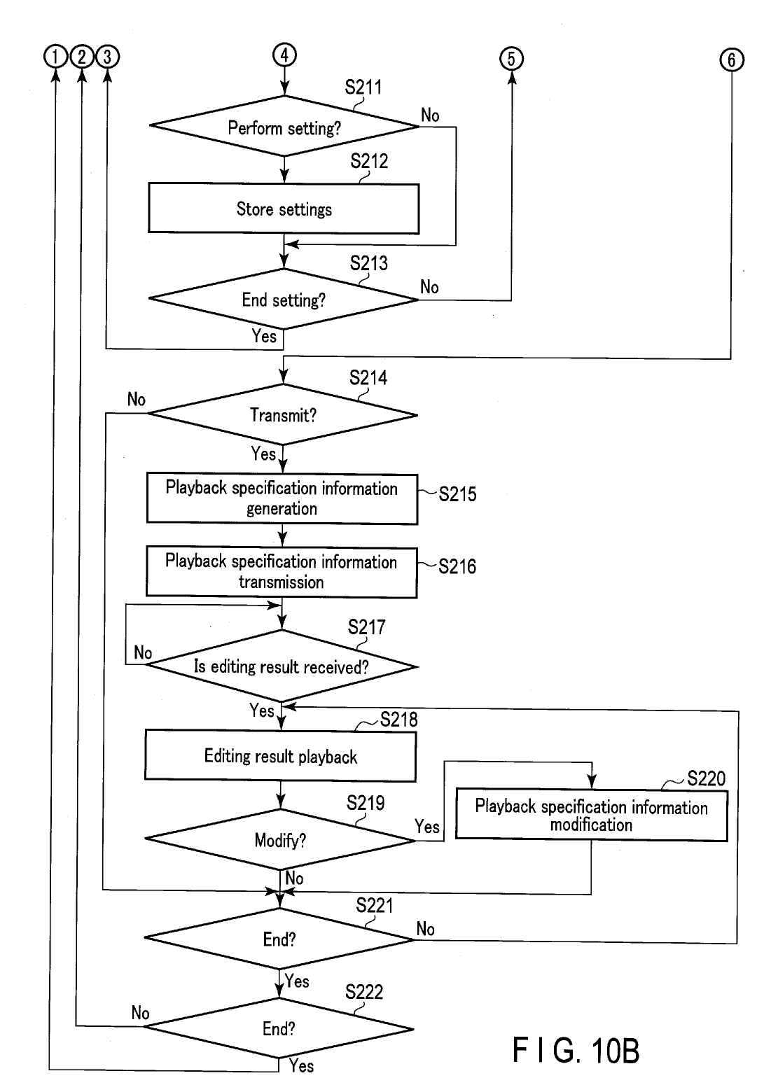

FIG. 8 is a diagram showing a configuration of a server apparatus as a specific example of the image processing device 30. As shown in FIG. 8, the server apparatus 300 includes a control circuit 301, a recording medium 302, a display 303, an operation unit 304, and a communication circuit 305.

The control circuit 301 corresponds to the control circuit 31, and is a control circuit comprising hardware, such as a CPU. The control circuit 301 includes an image processor 301a and a communication controller 301b. The image processor 301a corresponds to the data processor 31a, and performs editing processing for the recording data acquired by the digital camera 200. The communication controller 301b corresponds to the communication controller 31b, and controls communication by the communication circuit 305. The image processor 301a and the communication controller 301b are realized by, for example, using software. These may of course also be realized by using hardware.

The recording medium 302 corresponds to the recording medium 32, and is configured by, for example, a hard disk drive (HDD) and a solid state drive (SSD). Various kinds of programs to be executed in the control circuit 301 are recorded in the recording medium 302. An image transmitted from the digital camera 200 is recorded in the recording medium 302.

The display 303 which is, for example, a liquid crystal display or an organic EL display, displays various types of images.

The operation unit 304 includes various kinds of operation members for an operator of the server apparatus 300 to perform various kinds of operations for the server apparatus 300. The operation members include a keyboard, a mouse, and a touch panel.

The communication circuit 305 corresponds to the communication circuit 33. The communication circuit 305 includes, for example, a communication circuit corresponding to an Internet communication using an optical fiber. The communication circuit 305 may include a communication circuit, etc. corresponding to the Wi-Fi communication.

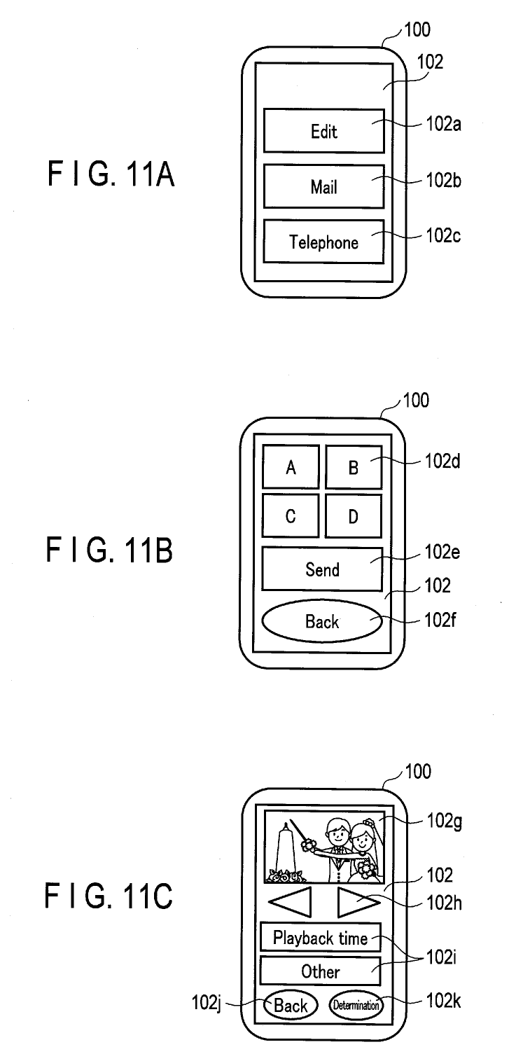

Hereinafter, an operation of a communication system of a specific example will be described. First, an operation of the digital camera 200 will be described. FIG. 9 is a flowchart showing an operation of the digital camera 200. The processing shown in FIG. 9 is controlled mainly by the control circuit 201.

In step S1, the control circuit 201 determines whether or not to turn the power of the digital camera 200 on. In step S101, for example, when an ON operation of the power of the digital camera 200 is performed by the user, it is determined to turn the power of the digital camera 200 on. In addition, in step S101, when there is a communication request, such as a request of related data, from the smartphone 100 to the digital camera 200, it is determined to turn the power of the digital camera 200 on. On the other hand, for example, when an OFF operation of the power of the digital camera 200 is performed by the user, it is determined to not turn the power of the digital camera 200 on. In addition, when a power off is instructed from the smartphone 100 to the digital camera 200, it is determined to not turn the power of the digital camera 200 on. In step S101, if it is determined to turn the power of the digital camera 200 on, the processing proceeds to step S102. In step S101, if it is not determined to turn the power of the digital camera 200 on, the processing shown in FIG. 9 is ended.

In step S102, the control circuit 201 determines whether or not there is a communication request from the smartphone 100 or the server apparatus 300. In step S102, if it is determined that there is no communication request from the smartphone 100 or the server apparatus 300, the processing proceeds to step S103. In step S102, if it is determined that there is a communication request from the smartphone 100 or the server apparatus 300, the processing proceeds to step S109.

In step S103, the control circuit 201 determines whether or not a current operation mode of the digital camera 200 is an image capture mode. The digital camera 200 includes the image capture mode and a playback mode as the operation modes. The image capture mode is an operation mode for displaying an image on the display 204 in a live view according to the user's operation, and performing an image capture operation to record an image in the recording medium 205. The playback mode is an operation mode to play back an image recorded in the recording medium 205 according to the user's operation. The digital camera 200 may of course include an operation mode other than the image capture mode and the playback mode. In step S103, if it is determined that the current operation mode of the digital camera 200 is the image capture mode, the processing proceeds to step S104. In step S103, if it is determined that the current operation mode of the digital camera 200 is not the image capture mode, the processing proceeds to step S118.

In step S104, the control circuit 201 performs live view display. The control circuit 201 directs the imaging element of the imaging unit 202 to start an imaging operation by an exposure setting for live view display. Then, the control circuit 201 processes an image acquired by the imaging operation in the image processing circuit 203, and transmits the processed image to the display 204. The control circuit 201 then controls the display 204 to display the image. In this way, the image acquired by the imaging element is displayed on the display 204 in real time. After such a live view display, the processing proceeds to step S105.

In step S105, the control circuit 201 determines whether or not to perform image capture. The image capture herein includes still image capture, consecutive still image capture, and movie image capture. For example, when any one of an instruction for still image capture, an instruction for consecutive still image capture, or an instruction for movie image capture is performed by the user's operation of the operation unit 207, it is determined to perform image capture. In step S105, if it is determined to perform image capture, the processing proceeds to step S106. In step S105, if it is determined to not perform image capture, the processing returns to step S101.

In step S106, the control circuit 201 executes an image capture operation. The control circuit 201 directs the imaging element of the imaging unit 202 to start an imaging operation by an exposure setting for still image capture, consecutive still image capture, or movie image capture. Then, the control circuit 201 processes the image acquired by the imaging operation in the image processing circuit 203, and stores the processed image in the RAM of the recording medium 205.

In step S107, the control circuit 201 determines whether or not to end the image capture. For example, in a case of still image capture, it is determined to end the image capture after ending the image capture operation of one time. For example, in a case of consecutive still image capture, it is determined to end the image capture after ending the image capture operation of a prescribed number of times. Furthermore, for example, in a case of a movie image, when an instruction for ending movie image capture is performed by the user's operation of the operation unit 207, it is determined to end the image capture. In step S107, if it is determined to end the image capture, the processing proceeds to step S108. In step S107, if it is determined to not end the image capture, the processing returns to step S106. In this case, the image capture is continued.

In step S108, the control circuit 201 records in the recording medium 205 as recording data the image which has been stored in the RAM. Subsequently, the processing returns to step S101.

In step S109, when it is determined that there is a communication request, the control circuit 201 determines whether or not to transmit related data. The related data is to be transmitted in response to a request from the smartphone 100. In step S109, if it is determined to transmit the related data, the processing proceeds to step S110. In step S109, if it is determined to not transmit the related data, the processing proceeds to step S113.

In step S110, the control circuit 201 determines whether or not to streaming-transmit the related data. Whether or not to streaming-transmit the related data is determined by, for example, an instruction from the smartphone 100. Alternatively, whether or not to streaming-transmit the related data may be configured to be set in advance in the digital camera 200. In step S110, if it is determined to not streaming-transmit the related data, the processing proceeds to step S111. In step S110, if it is determined to streaming-transmit the related data, the processing proceeds to step S112.

In step S111, the control circuit 201 controls the communication circuit 206 to transmit an image designated by the smartphone 100, as the related data, to the smartphone 100. The related data may be, for example, a thumbnail image of the designated image. In addition, the related data may be, for example, a low quality image, such as a reduced image and a thinned image, etc. of the designated image. Generation processing of these related data is performed by, for example, the image processing circuit 203. After transmitting the related data, the processing proceeds to step S113.

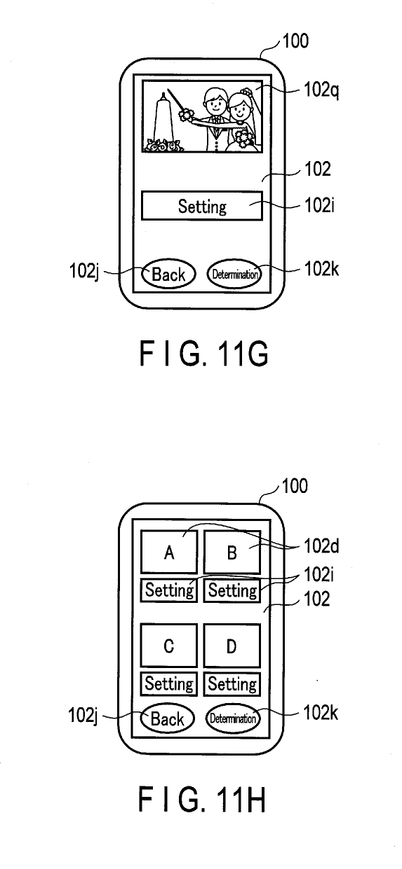

In step S112, the control circuit 201 controls the communication circuit 206 to streaming-transmit the related data. For example, if the recording data is a movie image or a consecutive image, the control circuit 201 transmits the related data sequentially from related data corresponding to a head frame. The related data may be, for example, a thumbnail image of each image. In addition, the related data may be, for example, a resized image, such as a reduced image and a thinned image, etc. of each image. Consecutive frames, each of which is resized, may be transmitted. By such processing of transmitting consecutive frames, it becomes easy to divide frames, etc. When needing to view an image on a mobile phone terminal, such as a smartphone, etc., there is often no problem with viewing a resized image. Thus, transmitting a resized image to a mobile phone terminal, such as a smartphone, etc. suppresses excess memory and energy consumption from a power supply, and can be said to be a preferable processing also in prioritizing immediacy and convenience of editing. Furthermore, since a streaming transmission with sequential playback is assumed, it is possible to check at approximately the same time as the image acquisition. Accordingly, it is possible to end without seeing all the data. Thus, it is possible to finish without requiring excessive tasks. In addition, the user can quickly retrieve only a part that the user wants to see, with a feeling of fast forwarding, rewinding, etc. For such a use, a resized screen is sufficient, and it is rather important that the data can be processed by light processing without requiring much memory and arithmetic operation. At a timing of step S112, retrieval, checking, deciding highlight, redo, etc. are frequently performed at the same time as such image checking. Operations of a graphic user interface shown in FIGS. 11A to 11G correspond thereto, and a signal corresponding to each operation is received and corresponding control is executed. Of course, there may be other controls, for example, for retrieving an image of a particular person's face, for retrieving a particular voice and word by sound, and a coordination in function, such as retrieving a particular frame by input setting of time. This generation processing of related data is performed in, for example, the image processing circuit 203. After transmitting the related data, the processing proceeds to step S113.

In step S113, the control circuit 201 determines whether or not to receive the playback specification information from the smartphone 100. In step S113, if it is determined that the playback specification information is received from the smartphone 100, the processing proceeds to step S114. In step S113, if it is determined that the playback specification information is not received from the smartphone 100, the processing returns to step S101.

In step S114, the control circuit 201 determines whether or not editing processing can be performed in accordance with the received playback specification information. If the editing processing can be performed in the image processing circuit 203 in accordance with the playback specification information, it is determined that the editing processing can be performed. In a case where editing processing not installed in the image processing circuit 203 is included in the playback specification information, etc., it is determined that the editing processing cannot be performed. In step S114, if it is determined that the editing processing can be performed in accordance with the received playback specification information, the processing proceeds to step S115. In step S114, if it is determined that the editing processing cannot be performed in accordance with the received playback specification information, the processing proceeds to step S117.

In step S115, the control circuit 201 instructs the image processing circuit 203 to execute the editing processing in accordance with the playback specification information. In response to this, the image processing circuit 203 performs the editing processing. The editing processing will be described together with editing processing in the server apparatus 300. After the editing processing, the processing proceeds to step S116. In step S116, the control circuit 201 controls the communication circuit 206 to streaming-transmit the edited recording data to the smartphone 100. Subsequently, the processing returns to step S101.

In step S117, the control circuit 201 controls the communication circuit 206 to transmit the playback specification information and the recording data to the server apparatus 300. Namely, the control circuit 201 requests the server apparatus 300 to perform the editing processing. Subsequently, the processing returns to step S101.

In step S118, the control circuit 201 determines whether or not the current operation mode of the digital camera 200 is the playback mode. In step S118, if it is determined that the current operation mode of the digital camera 200 is the playback mode, the processing proceeds to step S119. In step S118, if it is determined that the current operation mode of the digital camera 200 is not the playback mode, the processing returns to step S101.

In step S119, the control circuit 201 plays back the recording data designated by the user on the display 204. Namely, the control circuit 201 expands the recording data compressed and recorded in the recording medium 205 in the image processing circuit 203, and inputs the expanded recording data into the display 204. The display 204 displays an image based on the input recording data. Subsequently, the processing proceeds to step S120. The user can also edit the recording data by operating the operation unit 207 during playback of the recording data.

In step S120, the control circuit 201 determines whether or not an instruction to transmit the recording data during playback as the related data is performed by the user's operation of the operation unit 207. In the present embodiment, a part of the recording data during playback can be extracted as the related data. For example, the user determines an image or a frame that he/she wants to edit while looking at an image being displayed on the display 204 as a result of playback of the recording data. Then, when finding the image that the user wants to edit, he/she operates the operation unit 207. Thereby, in the control circuit 201, it is determined that the instruction to transmit the recording data during playback as the related data is performed. In step S120, if it is determined that the instruction to transmit the recording data during playback as the related data is performed, the processing proceeds to step S121. In step S120, if it is determined that the instruction to transmit the recording data during playback as the related data is not performed, the processing proceeds to step S122.

In step S121, the control circuit 201 controls the communication circuit 206, and transmits an image designated by the user to the smartphone 100, as the related data. If the recording data being played back is a movie image or consecutive still images, the control circuit 201 extracts the designated image among the movie image or consecutive still images being played back and transmits the designated image. Subsequently, the processing proceeds to step S122.

In step S122, the control circuit 201 determines whether or not to end the playback of recording data. For example, when an instruction to end the playback of the recording data is performed by the user's operation of the operation unit 207, or when playback of an image of a final frame is ended when the recording data is a movie image or consecutive still images, it is determined to end the playback of recording data. In step S122, if it is determined to end the playback of recording data, the processing returns to step S101. In step S122, if it is determined to not end the playback of recording data, the processing returns to step S119.

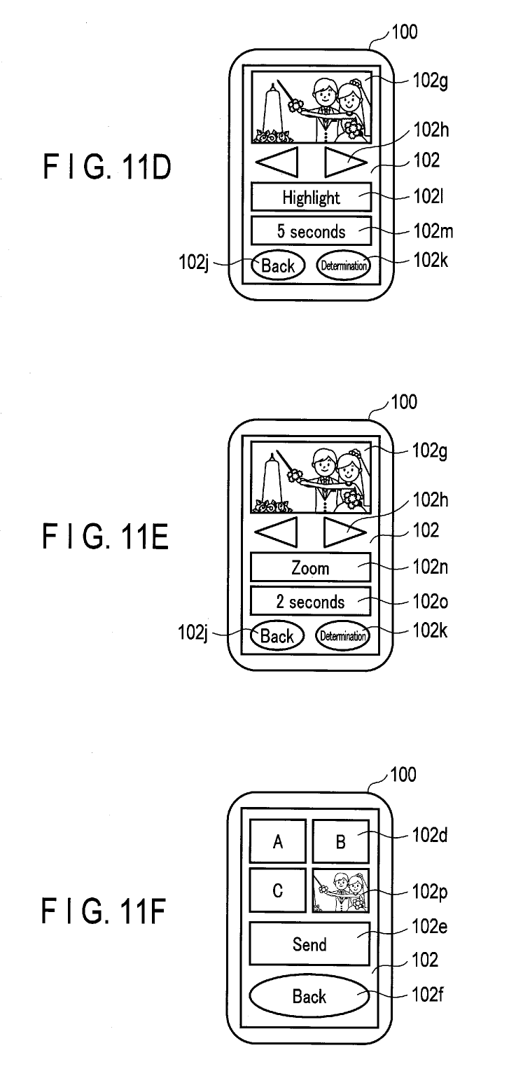

Next, an operation of the smartphone 100 will be described. FIGS. 10A and 10B are flowcharts showing the operation of the smartphone 100. The process shown in FIGS. 10A and 10B is controlled mainly by the control circuit 101.

In step S201, the control circuit 101 determines whether or not to turn on the power of the smartphone 100. For example, when a power button of the smartphone 100 is pushed by the user, it is determined to turn on the power of the smartphone 100. In step S201, if it is determined to turn on the power of the smartphone 100, the processing proceeds to step S202. In step S201, if it is determined to not turn on the power of the smartphone 100, the process shown in FIGS. 10A and 10B ends.

In step S202, the control circuit 101 directs the display 102 to display an icon representing an application installed in the smartphone 100. FIG. 11A shows a display example of icons. In the example of FIG. 11A, an editing icon 102a representing an edit application, a mail icon 102b representing a mail application, and a telephone icon 102c representing a telephone application, are displayed as icons. When other applications have been installed in the smartphone 100, icons other than the edit icon 102a, the mail icon 102b, and the telephone icon 102c may, of course, be displayed as well.

In step S203, the control circuit 101 determines whether or not an edit application is selected by the user, i.e., whether or not the edit icon 102a is selected by the user. In step S203, if it is determined that the edit application is not selected by the user, the processing proceeds to step S204. In step S203, if it is determined that the edit application is selected by the user, the processing proceeds to step S205.

In step S204, the control circuit 101 performs the other processing. For example, when a mail application is selected, the control circuit 101 activates the mail application and performs processing related to the mail application. In addition, when a telephone application is selected, the control circuit 101 activates the telephone application and performs processing related to the telephone application. After the other processing, the processing returns to step S201.

In step S205, the control circuit 101 activates the edit application. Then, the control circuit 101 directs the display 102 to display a setting screen for editing. Subsequently, the processing proceeds to step S206. FIG. 11B is a diagram showing an example of a setting screen. In the example, a camera-blocking template 102d is first displayed. In the example of the present embodiment, a movie image or consecutive still images are edited in each of a plurality of cuts from an introduction to a conclusion. As the camera-blocking template 102d shown in FIG. 11B, for example, icons representing four cuts (cuts A, B, C, and D) from the introduction to the conclusion are displayed. In addition, on the setting screen, a send button 102e and a back button 102f are also displayed. The send button 102e is a button to be selected by the user when the user finishes the editing and sends the playback specification information from the smartphone 100 to the digital camera 200. The back button 102f is a button to be selected by the user when ending the edit application. The number of divisions of cuts is not limited to four. The number of divisions of cuts may be set by the user.

In step S206, the control circuit 101 determines whether or not a cut selection is performed by the user. For example, when any icon of the cuts A, B, C, and D is selected by the user, it is determined that the cut selection is performed. In step S206, if it is determined that the cut selection is performed by the user, the processing proceeds to step S207. In step S206, if it is determined that the cut selection is not performed by the user, the processing proceeds to step S214. Herein, there are four cuts, like an introduction, development, turn, and conclusion. However, the number of cuts may be increased or decreased by touch and slide operations of the screen, etc.

In step S207, the control circuit 101 controls the communication circuit 105 to request the related data from the digital camera 200. Subsequently, the processing proceeds to step S208. The control circuit 101, for example, requests a list of the related data from the digital camera 200. The user who sees this list selects a file containing the recording data that he/she wants to edit. In response to this selection, the control circuit 101 requests the digital camera 200 to transmit the related data of the image contained in the selected recording data. At this time, the control circuit 101 may request to streaming-transmit the related data in accordance with the user's operation. For example, if the data is very short data, its original file may be transmitted as it is, or an image of the original file that is resized and filed may be transmitted. Furthermore, only a particular frame may be cut out as a still image and may be transmitted. In addition, a technique of requesting the related data is not limited to the technique described above. For example, the selection of recording data may be performed prior to display of the setting screen.

In step S208, the control circuit 101 determines whether or not the related data is received. In step S208, if it is determined that the related data is received, the processing proceeds to step S209. In step S208, if it is determined that the related data is not received, the processing proceeds to step S207. In this case, the request for the related data is continued. In a case where the related data is not received for a certain time, the processing may be configured to time-out. In this case, it is desirable to notify the user that the processing has timed-out.

In step S209, the control circuit 101 updates the setting screen. Subsequently, the processing proceeds to step S210. FIG. 11C shows a setting screen after update. When the related data is received, the received related data is played back. For example, if the related data is an image, an image 102g as the related data is displayed on the display 102 as shown in FIG. 11C. The image 102g is, for example, a thumbnail image. In addition, on the updated setting screen, a forward/reverse button 102h, a setting button 102i, a back button 102j, and a determination button 102k are also displayed. The forward/reverse button 102h is a button to be selected by the user when switching of the related data to be played back is performed. The setting button 102i is a button to be selected by the user when setting playback specifications related to a cut being currently selected. The setting button 102i includes a playback time button and an other button. The playback time button is a button to be selected by the user when setting a playback time of a cut being currently selected. The other button is a button to be selected by the user when setting other than the playback time. When the other button is selected, for example, it becomes possible to further select necessary settings by a drop-down list. The back button 102j is a button to be selected by the user when returning to the selection screen of camera-blocking which is the previous screen, without deciding the playback specifications for the cut being currently selected. The determination button 102k is a button to be selected by the user when deciding the playback specifications for the cut being currently selected. In addition, in a case where a still image is used for the cut, a display time and a transition effect may be applied so that the still image can be treated as a movie image. This means that if a still image is copied for that time period and various effects are applied as a movie image frame, the still image would become an equivalent to a movie image. For example, an effect of trimming, etc. can be treated as a movie image captured by zooming or panning. Other than that, it may correspond to image processing of special effects, etc. At this time, it is preferable to make it possible to apply a similar effect on both the interface device side and the capture device side, and to confirm the applied effect. On the other hand, the specification may be such that the kind of image processing is merely designated on the interface device side, and actual processing is performed on the capture device side. Even in this case as well, an effect that detailed processing is performed on the capture device side based on a simple operation of the interface device side can be obtained.

In step S210, the control circuit 101 determines whether or not to change the related data. For example, when the forward/reverse button 102h is selected by the user, it is determined to change the related data. Other than that, it may be determined to change the related data when a swipe operation for the image 102g is performed by the user. In step S210, if it is determined to change the related data, the processing returns to step S207. In this case, according to the user's operation, transmission of previous or subsequent related data of the related data being played back is requested to the digital camera 200. In step S210, if it is determined to not change the related data, the processing proceeds to step S211.

In step S211, the control circuit 101 determines whether or not to perform setting related to the cut being selected. For example, when the setting button 102i is selected by the user, it is determined to perform the setting. In step S211, if it is determined to perform the setting related to the cut being selected, the processing proceeds to step S212. In step S211, if it is determined to not perform the setting related to the cut being selected, the processing proceeds to step S213.

In step S212, the control circuit 101 directs the display 102 to display a setting screen of playback specifications. Then, the control circuit 101 directs the RAM of the recording medium 104 to store the playback specifications set according to the user's operation. Subsequently, the processing proceeds to step S213. FIGS. 11D and 11E are display examples of a playback specification setting screen. In setting of playback specifications, the user can perform setting of playback time of a cut being selected, setting of special effects, setting of BGM, setting of captions, and setting of transition effects. FIG. 11D is a display example when the setting of playback time is selected by the user. In setting of playback time, a character string 1021 of “Highlight” for explicitly indicating to the user that it is currently the setting of playback time and a setting display 102m for setting playback time are displayed. The setting display 102m is configured, for example, such that the user can select a preferable time from some playback time candidates in a drop-down list form. In FIG. 11D, “5 seconds” is selected as a playback time. In this case, in subsequent editing processing, a frame of 5 seconds before and after a frame corresponding to the related data being currently played back is extracted as a highlight image to be played back during the cut A. In addition, FIG. 11E is a display example when setting of zooming as one example of the special effects is selected by the user. In the setting of zooming, a character string 102n of “Zoom” for explicitly indicating to the user that it is currently the setting of zooming and a setting display 102o for setting a zoom playback time are displayed. In the setting of zooming, the user, for example, touches a part of the related data being played back. Then, the user sets the zoom playback time on the setting display 102o. The setting display 102o is also configured such that, for example, the user can select a preferable time from some playback time candidates in a drop-down list form. In FIG. 11E, “2 seconds” is selected as the zoom playback time. In this case, in subsequent editing processing, image processing is performed so that a portion touched by the user is zoomed and played back for 2 seconds.

In step S213, the control circuit 101 determines whether or not to end the setting. For example, when the back button 102j or the determination button 102k is selected by the user, it is determined to end the setting. In step S213, if it is determined to end the setting, the processing returns to step S205. At this time, when the back button 102j is selected, the setting stored in the RAM in step S212 is cleared. In addition, when the determination button 102k is selected, the control circuit 101 updates the setting screen as shown in FIG. 11F. Namely, the control circuit 101 plays back related data 102p, which is being played back when the determination button 102k is selected, in a position of the cut icon previously selected. In addition, in step S213, if it is determined to not end the setting, the processing returns to step S210. In this case, the setting of the cut being selected is continued.

In step S214 when it is determined that the selection of cut is not performed by the user, the control circuit 101 determines whether or not to transmit the playback specification information. For example, when the send button 102e is selected by the user, it is determined to send the playback specification information. In step S214, if it is determined to send the playback specification information, the processing proceeds to step S215. In step S214, if it is determined to not send the playback specification information, the processing proceeds to step S222.

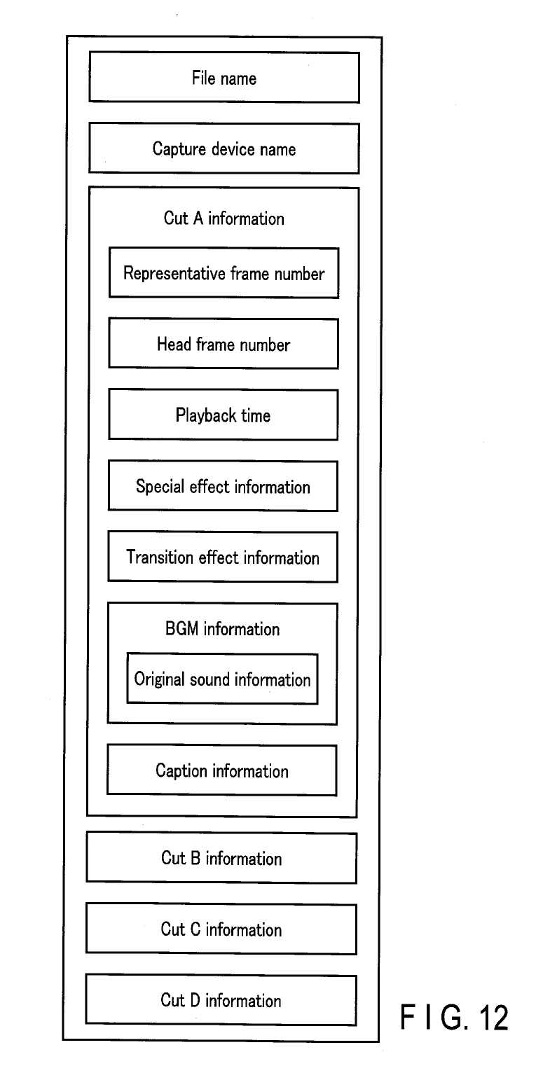

In step S215, the control circuit 101 generates the playback specification information in accordance with information stored in the RAM. The playback specification information is, for example, information to be managed as a text file. FIG. 12 is a diagram showing an example of playback specification information when the recording data is a movie image. The recording data may of course be a still image. If a still image is displayed for a particular time, it can be treated as a movie image capturing a non-moving object for that time. In addition, if a transition effect is applied to the image, which was originally a still image, it will be an image equivalent to a movie image.

As shown in FIG. 12, the playback specification information includes a file name, a capture device name, cut A information, cut B information, cut C information, and cut D information.

The file name is a text indicating a file name of recording data which is an editing target.

The capture device name is a text indicating a capture device in which recording data that is an editing target is recorded, for example, a text indicating a model name of a digital camera. The capture device name may be an ID, etc., not a name.

The cut A information is a text indicating setting related to the cut A. The cut A information includes a representative frame number, a head frame number, a playback time, special effect information, transition effect information, BGM information, and caption information.

The representative frame number is text information indicating a frame number of a representative frame which is an image representing images belonging to the cut A. The representative frame is, for example, a frame corresponding to related data that is being played back at the time of selection. The head frame number is text information indicating a frame number of a head frame that is a head image of the cut A. The head frame is a frame preceding for a playback time of the representative frame. For example, if the playback time is set to 5 seconds, the head frame is a frame at five seconds before the representative frame. The playback time is text information indicating a playback time of the cut A. The special effect information is text information indicating a content of a special effect applied to the cut A. The special effect includes processing, such as zooming, shading, and monochrome. The transition effect information is text information indicating a content of a transition effect applied to the cut A. The transition effect includes processing, such as fade-in, fade-out, and wipe. The BGM information is text information indicating a URL of an address in which a name of a BGM associated with the cut A, or in which the BGM is stored. In addition, the BGM information includes original sound information. The original sound information is text information indicating whether or not to retain or delete a sound recorded along with a movie image at a timing of the cut A. Since there is a case where a sound to be recorded along with a movie image may be a mere noise, the user can instruct to retain or delete an original sound in the present embodiment. The caption information is text information including the content of a caption associated with the cut A. The content of a caption includes character font, character size, color, etc. of the caption.

Similarly to the cut A information, the cut B information, the cut C information, and the cut D information include a representative frame number, a head frame number, a playback time, special effect information, transition effect information, BGM information, and caption information in their corresponding cuts. In FIG. 12, however, illustration thereof is omitted.

It is assumed herein that the playback specification information is managed in a form of a text file, but the playback specification information does not need to be necessarily managed as a text file. In addition, the playback specification information may include information other than those shown in FIG. 12. For example, the playback specification information may include a text indicating a history of setting by the user. By storing such a user's setting history, it is possible to analyze the user's preferences of editing, etc. By utilizing this analysis result, it is expected to present to the user a content of editing suitable for the user. In addition, the playback specification information may include a text indicating a content of editing. For example, even in the zoom setting, a text such as “zoom gradually” may be included.

Herein, the explanation continues with reference back to FIG. 10B. In step S216, the control circuit 101 controls the communication circuit 105 to transmit the playback specification information to the digital camera 200. Subsequently, the processing proceeds to step S217.

In step S217, the control circuit 101 determines whether or not the recording data as an editing result is streaming-transmitted from the digital camera 200 or the server apparatus 300. In step S217, if it is determined that the recording data as an editing result is not transmitted from the digital camera 200 or the server apparatus 300, the processing stands by. In step S217, if it is determined that the recording data as an editing result is transmitted from the digital camera 200 or the server apparatus 300 for a predetermined time, the processing proceeds to step S218.

In step S218, the control circuit 101 plays back the recording data transmitted. For example, if the recording data is a movie image, the control circuit 101 plays back the movie image streaming-transmitted sequentially on the display 102. Subsequently, the processing proceeds to step S219. FIG. 11G is an example of a movie image display. When a movie image is displayed, a movie image 102q transmitted from the digital camera 200 or the server apparatus 300 is sequentially played back on the display 102. At this time, the setting button 102i, the back button 102j, and the determination button 102k are also displayed.

In step S219, the control circuit 101 determines whether or not to modify the playback specifications. For example, it is determined to modify the playback specification when the setting button 102i is selected by the user. In step S219, if it is determined to modify the playback specifications, the processing proceeds to step S220. In step S219, if it is determined to not modify the playback specifications, the processing proceeds to step S221.

In step S220, the control circuit 101 accepts the user's setting operation in the same manner as step S212, and modifies the playback specification information according to the user's setting operation. Subsequently, the processing proceeds to step S221.

In step S221, the control circuit 101 determines whether or not to end the modification of the playback specification information. For example, when the back button 102j or the determination button 102k is selected by the user, it is determined to end the setting. In step S221, if it is determined to end the modification of the playback specification information, the processing proceeds to step S222. At this time, the control circuit 101 returns the display of the display 102 to the setting screen shown in FIG. 11F. In addition, when the back button 102j is selected, the content modified in step S220 is cleared. In step S221, if it is determined to not end the modification of the playback specification information, the processing returns to step S218. In this case, the playback of the movie image is continued.

In step S222, the control circuit 101 determines whether or not to end the edit application. For example, it is determined to end the edit application when the back button 102j is selected by the user. In step S222, when it is determined to end the edit application, the processing returns to step S201. At this time, the control circuit 101 instructs the digital camera 200 to turn the power off. In addition, the control circuit 101 notifies to the server apparatus 300 that the edit application is ended. In step S222, when it is determined to not end the edit application, the processing returns to step S205.

Herein, the setting screen displayed at the time of activation of the edit application is not limited to those shown in FIGS. 11A to 11G. For example, the setting screen may be something shown in FIG. 11H. Namely, FIGS. 11A to 11G are such that setting of playback specifications is performed after cut selection is performed, whereas FIG. 11H is a selection screen that enables selection of camera-blocking and setting of playback specifications at the same time. In the setting screen shown in FIG. 11H, a setting button 102i is displayed in the vicinity of each of the individual cut icons A, B, C, and D included in the camera-blocking template 102d. In the setting screen shown in FIG. 11H, the positions of the cuts A, B, C, and D may be configured to be switchable by a drag-and-drop operation.

In the above-described example, the related data to be played back in the position of the cut icon as shown in FIG. 11F is requested to the digital camera 200 as necessary. In contrast, the related data may be acquired at the time of activating the edit application in advance. In this case, at the time of activating the edit application, selection of the recording data by the user is performed.

Furthermore, in the examples shown in FIGS. 10A and 10B, it is possible to transmit the playback specification information even if not all the cut icons A, B, C, and D are assigned with images. Thus, the processing of the present embodiment can be applied to a still image. On the other hand, it is possible to configure that the playback specification information can be transmitted when all the cut icons A, B, C, and D are assigned with images.

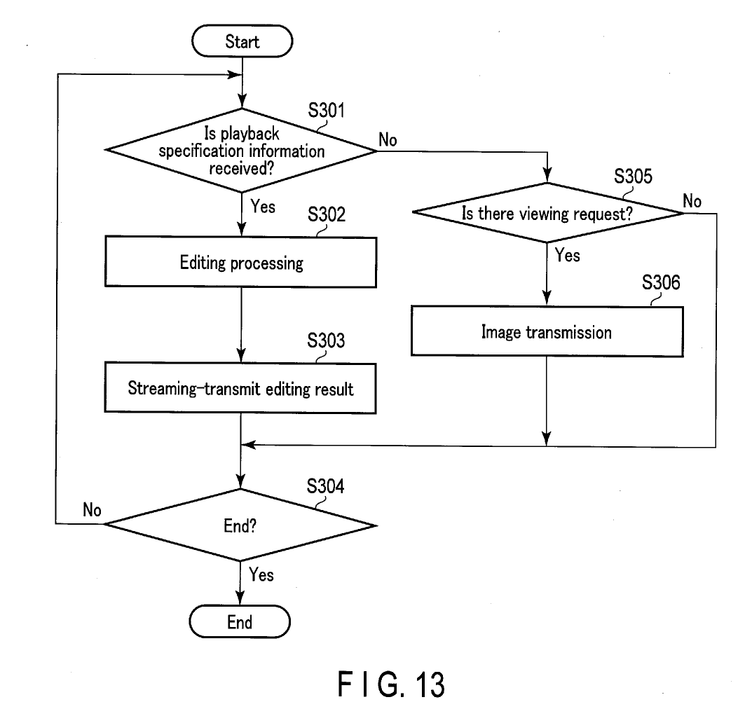

Subsequently, the operation of the server apparatus 300 will be described. FIG. 13 is a flowchart indicating the operation of the server apparatus 300. The operation shown in FIG. 13 is controlled mainly by the control circuit 301.

In step S301, the control circuit 301 determines whether or not to receive the playback specification information from the digital camera 200 via the communication circuit 305. In step S301, if it is determined that the playback specification information is received, the processing proceeds to step S302. In step S301, if it is determined that the playback specification information is received, the processing proceeds to step S305.

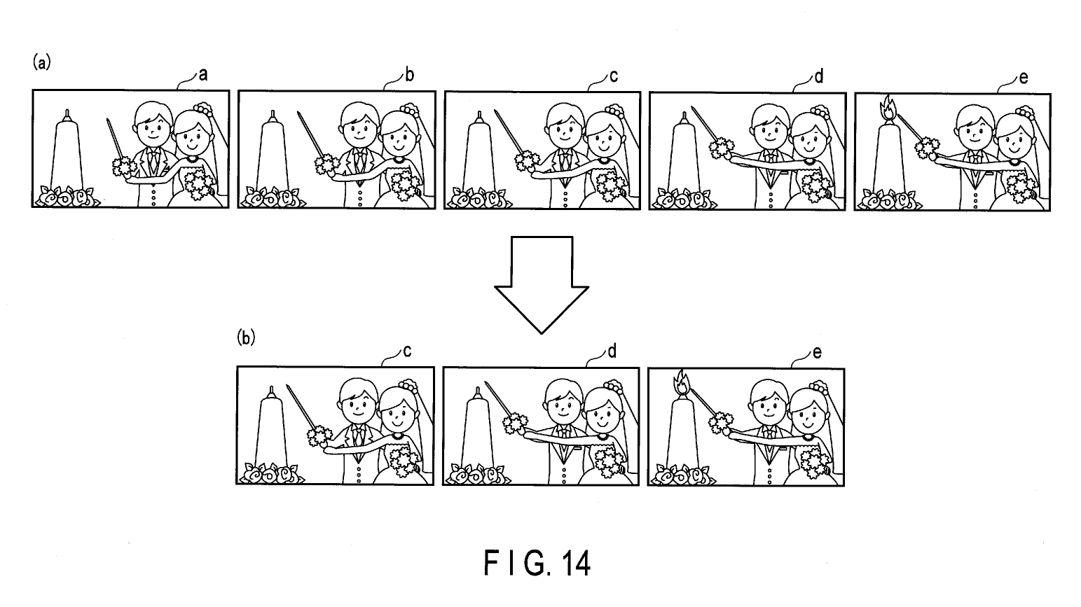

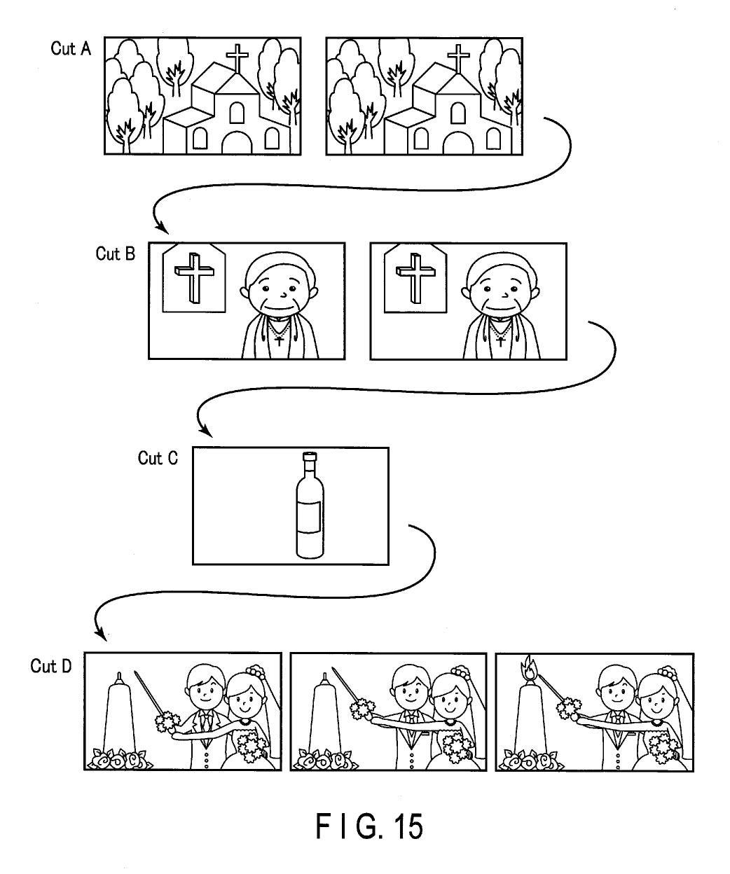

In step S302, the control circuit 301 executes editing processing in accordance with the playback specification information. Subsequently, the processing proceeds to step S303. For example, it is assumed that a playback time of the cut D recorded in the playback specification information is 5 seconds, and that a representative image of the cut D is an image d among images included in the recording data shown in (a) of FIG. 14. At this time, among images a to e shown in (a) of FIG. 14 that are transmitted from the digital camera 200 along with the playback specification information, the control circuit 301 extracts images c to e at 5 seconds before and after the image d as a center as shown in (b) of FIG. 14, as highlight images included in the cut D. Such an extraction of highlight images is also performed for the cuts A, B, and C so as to generate recording data in which only highlight images are to be played back in the order of cuts A, B, C, and D as shown in FIG. 15.

The control circuit 301 may be configured to first receive only the playback specification information, and to acquire only necessary recording data from the digital camera 200. In this case, the control circuit 301 requests only images at 5 seconds before and after the image d as a center from the digital camera 200. The digital camera 200 transmits only the images c, d, and e in response to this request.

In addition, the editing processing in the server apparatus 300 may be performed by a manual operation by the operator. In this case, the operator may perform the editing processing in accordance with a text, such as “zoom gradually”, recorded in the playback specification information. Furthermore, the editing processing in the server apparatus 300 may be performed by using artificial intelligence. In this case, the server apparatus 300 may learn the content of editing from the text, such as “zoom gradually”, recorded in the playback specification information to perform the editing processing.

In step S303, the control circuit 301 controls the communication circuit 305 to streaming-transmit the edited recording data to the smartphone 100. Subsequently, the processing proceeds to step S304.

In step S304, the control circuit 301 determines whether or not to end the processing. For example, when ending of the edit application is notified from the smartphone 100, when the streaming transmission is ended, or ending of the image viewing is instructed by the user after step S306, it is determined to end the processing. In step S304, if it is determined to end the processing, the processing shown in FIG. 13 is ended.

In step S305, the control circuit 301 determines, for example, whether or not there is an image viewing request from the smartphone 100. In step S305, if it is determined that there is an image viewing request, the processing proceeds to step S306. In step S305, if it is determined that there is no image viewing request, the processing proceeds to step S304.

In step S306, the control circuit 301 transmits a requested image to the smartphone 100. Subsequently, the processing proceeds to step S304.

As described above, according to the present embodiment, only an operation for editing of recording data recorded in a recording medium of a capture device is performed in an interface device, and actual editing processing is performed in the capture device or an image processing device. Thus, a processing load and a communication load in the interface device can be reduced. Since communication of the recording data itself is not performed, a communication load in the interface device can be reduced.

Since the editing processing is performed in equipment other than the interface device, editing processing that cannot be performed only by the interface device (e.g., smartphone) can also be performed.

In addition, when transmitting related data, the related data is streaming-transmitted as necessary. Thereby, the load in interface device can be reduced more than simply transmitting the related data. Similarly, by streaming-transmitting the recording data also when checking an editing result, the load upon an interface device can be reduced more than simply transmitting the recording data.

The present invention has been explained based on the embodiment; however, the present invention is not limited to the embodiment. The present invention may, of course, be modified in various ways without departing from the spirit and scope of the invention. For example, in the above-described embodiment, an image is mainly raised as an example of the recording data. However, the technique of the present embodiment can be applied to various kinds of recording data other than images, such as a voice.

It should be noted that, in the embodiment, a part named as a “part” (a section or a unit) may be structured by a dedicated circuit or a combination of a plurality of general circuits, and may be structured by a combination of a microcomputer operable in accordance with a pre-programmed software, a processor such as a CPU, or a sequencer such as an FPGA. In addition, a design where a part or all of the control is performed by an external device can also be adopted. In this case, a communication circuit is connected by wire or wireless. Communication is only required to be performed by a Bluetooth communication, a Wi-Fi communication, a telephone circuit, etc., and may be performed by a USB, etc. A dedicated circuit, a general purpose circuit, or a controller may be integrally structured as an ASIC.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An interface device for data editing, comprising:
a control circuit configured to:
(1) acquire from a capture device related data for checking content of recording data recorded in a recording medium of the capture device, and
(2) play back the related data to be viewable on a setting screen;
an operation unit configured to accept an operation of setting of playback specifications on the setting screen; and
a communication circuit configured to transmit playback specification information indicating the set playback specifications to the capture device.

2. The interface device for data editing according to claim 1, wherein the related data is data with a data capacity smaller than the recording data.

3. The interface device for data editing according to claim 1, wherein the related data is data to be stream-transmitted from the capture device.

4. The interface device for data editing according to claim 1, wherein the related data is data generated by extracting a part of the recording data being played back in the capture device.

5. The interface device for data editing according to claim 1, wherein the recording data is constituted by a plurality of temporally-consecutive images, and
the playback specifications include at least any one of a playback order of the images, a playback time of each of the images, a BGM to be played back along with each of the images, a caption to be played back along with each of the images, and an image effect to be applied at a time of playback of each of the images.

6. The interface device for data editing according to claim 1, wherein the playback specification information is managed by a text file.

7. A capture device comprising a data processing circuit configured to process the recording data so as to be played back in accordance with the playback specification information transmitted from the interface device for data editing according to claim 1.

8. An image processing device comprising a data processor configured to process the recording data so as to be played back in accordance with the playback specification information transmitted from the interface device for data editing according to claim 1.

9. A data editing method comprising:
displaying on a display a setting screen for setting playback specifications of recording data recorded in a recording medium of a capture device;
acquiring from the capture device related data for checking content of the recording data and playing back the related data along with display of the setting screen;
accepting an operation of setting of the playback specifications on the setting screen; and
transmitting to the capture device playback specification information indicating the set playback specifications.

10. A computer-readable non-transitory storage medium storing a data editing program to cause a computer to execute:
displaying on a display a setting screen for setting playback specifications of recording data recorded in a recording medium of a capture device;
acquiring from the capture device related data for checking content of the recording data and playing back the related data along with display of the setting screen;
accepting an operation of setting of the playback specifications on the setting screen; and
transmitting to the capture device playback specification information indicating the set playback specifications.
